(19) United States
(12) Patent Application Publication
(10) Pub. No.: US 2014/0379413 A1
(43) Pub. Date: Dec. 25, 2014

(54) GROUPING PROCESS STRUCTURES IN A SOLUTION MANAGER UNIFIED DIRECTORY

(71) Applicants: Michael Volkmer, Heidelberg (DE); Martin Naumann, Reilingen (DE)

(72) Inventors: Michael Volkmer, Heidelberg (DE); Martin Naumann, Reilingen (DE)

(73) Assignee: SAP AG, Walldorf (DE)

(21) Appl. No.: 13/922,462

(22) Filed: Jun. 20, 2013

(51) Int. Cl. G06Q 10/06

(52) U.S. Cl. CPC G06Q 10/06316
USPC 705/7.26

(57) ABSTRACT

Techniques for managing business process functionality by grouping process structures in a solution manager unified directory (SMUD) include defining a group for a SMUD, the defined group including a group identification (ID) and a plurality of members of the group, each member including a business process structure; defining a plurality of generic functions of the group; receive a request for an adjustment to the plurality of generic functions of a particular member of the plurality of members of the group; and based on the received request, adjusting the plurality of generic functions of members of the group other than the particular member.

### TECHNICAL BACKGROUND

This disclosure relates to grouping process structures in a solution manager unified directory and, more particularly, grouping sub-sets of process structures in a solution manager unified directory to provide for group functionality.

### BACKGROUND

A solution manager unified directory (“SMUD”) provides a platform to manage business processes that are supported by enterprise software (e.g., Enterprise Resource Planning, Customer Relationship Management software, and otherwise). The processes are designed based on business requirements, implemented in the software (e.g., via customizing), tested, and finally deployed into production where they are executed. In some cases, a process hierarchy manages different levels (e.g., scenario, process, process steps) in a tree structure. In a SMUD, the levels of this structure can be defined via the corresponding SMUD model so that the levels are not predefined. During the lifecycle of the process structure, several versions of the structure may be needed. The different versions may be changed independently and a compare and merge functionality can be used to handle the versions. Different data and features may be associated with the process structure. Some features may only need to be applied to parts (sub-sets) of the structure (e.g., a change request).

In some cases, certain operations in SMUD can only be performed if the correct authorization for the corresponding user is available. In addition, such operations may be reduced to only certain parts of the data (e.g., reduced to certain occurrences). This may require multiple authorizations, logging, and other features to be associated with the operation.

### SUMMARY

The present disclosure relates to computer-implemented methods, computer-readable media, and computer systems for managing business process functionality by grouping process structures in a SMUD. One computer-implemented method includes defining a group for a solution manager unified directory (SMUD), the defined group including a group identification (ID) and a plurality of members of the group, each member including a business process structure; defining a plurality of generic functions of the group; receive a request for an adjustment to the plurality of generic functions of a particular member of the plurality of members of the group; and based on the received request, adjusting the plurality of generic functions of members of the group other than the particular member.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In a first aspect combinable with any of the implementations, the defined group further includes a group header that includes the group ID and the plurality of members of the group, the group header further including one or more user authorizations, the user authorizations defining approved adjustments to the plurality of generic functions.

In a second aspect combinable with any of the previous aspects, the one or more user authorizations include a creator authorization and one or more group authorizations.

A third aspect combinable with any of the previous aspects further includes based on the received request, determining a user that made the request; checking the user and the request against the user authorizations; and based on the user and request being an approved adjustment, adjusting the plurality of generic functions.

In a fourth aspect combinable with any of the previous aspects, the adjustment to the plurality of generic functions includes at least one of: an addition of a new function; a change to an authorization level of a user; an addition of a new member to the members of the group; or a change to data in at least one of the members of the group.

In a fifth aspect combinable with any of the previous aspects, adjusting the plurality of generic functions of members of the group other than the particular member includes adjusting the plurality of generic functions of members of the group other than the particular member without adding code to any of the members of the group.

In a sixth aspect combinable with any of the previous aspects, at least a portion of the plurality of generic functions includes a read function, a copy function, and a delete function.

Various implementations of techniques for managing business process functionality by grouping process structures in a SMUD as described in the present disclosure may include none, one, some, or all of the following features. For example, such techniques may greatly reduce an amount of code generated to add functionality to a common group of business process structures. As another example, such techniques may reduce maintenance and total cost of ownership (TCO) for a code base that supports the business process structures. As another example, such techniques may reduce an occurrence of errors in a code base that supports the business process structures by, for example, minimizing code changes that implement changes to a functionality of business process structures.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example distributed computing system for grouping process structures in a SMUD;

FIG. 2A illustrates an example system architecture for grouping process structures in a SMUD;

FIG. 2B illustrates an example process hierarchy for grouping process structures in a SMUD;

FIG. 2C illustrates an example group header definition in an architecture for grouping process structures in a SMUD;

FIGS. 3A-3B illustrate example sub-structures of a SMUD instance in an architecture for grouping process structures in a SMUD; and

FIGS. 4A-4B illustrate example group interface hierarchies for grouping process structures in a SMUD.

### DETAILED DESCRIPTION

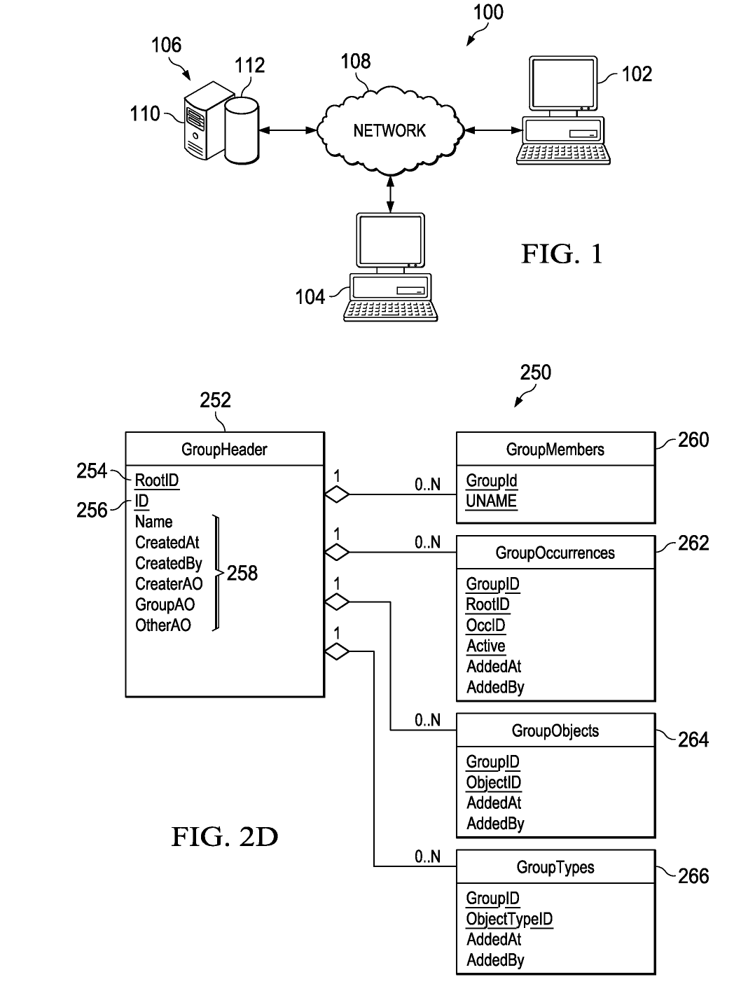

FIG. 1 illustrates an example distributed computing environment 100 for grouping process structures in a SMUD. For example, in some aspects, environment 100 may facilitate an option to define SMUD groups that allows for generic group functionality for a variety of use cases. For example, group specific functionality may be provided through an enhancement concept based on inheritance that allows an overwrite of, or an enhancement to, the generic group functionality. In addition, the group concept may be associated with authorization features that allow a user to manage particular functionality (e.g., display, edit, delete) applied to the group members (e.g., the sub-set of processes). In some aspects, computing environment 100 may facilitate techniques for grouping process structures in a SMUD by facilitating a generic concept that allows generic group functionality for a variety of functions. If group specific functionality is needed, an enhancement concept based on inheritance allows an enhancement to the generic functionality. In addition, the group concept may be associated with authorization features that manage which users can perform which functionality (e.g. display, edit, delete).

Turning to the example implementation of FIG. 1, the illustrated environment 100 includes one or more clients 102, at least some of which require access to secure data owned by the resource owner 104 and protected by the computer system 106. The client computing devices 102 and resource owner 104 can communicate with one or more of the computer systems 106 over a network 108. The computer system 106 can include one or more servers 110 and one or more data stores 112. In some implementations, the system 100 may represent a client/server system supporting multiple computer systems 106 including one or more clients (e.g., client computing devices 102 and resource owners devices 104) that are connectively coupled for communication with one another over the network 108.

The client computing devices 102 and resource owner devices 104 can represent various forms of processing devices including, but not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The client computing devices 102 and resource owner devices 104 can access application software on one or more of the computer systems 106.

The computer system 106 can represent various forms of server systems including, but not limited to a web server, an application server, a proxy server, a network server, or a server farm. For example, one or more of the servers 110 can be an application server that executes software accessed by the client computing devices 102 and resource owner devices 104. In some implementations, the computer system 106 disposes of a configuration interface that can extend Integrated Development Environments (IDE's) to support the integration of new protocols into web or cloud applications. A user can invoke applications available on one or more of the servers 110 in a web browser running on a client (e.g., client computing device 102 and resource owner devices 104). Each application can individually access data from one or more repository resources (e.g., datastores 112). The computer system 106 can include a storage device to store information. In one implementation, the storage device is a volatile memory unit. In another implementation, the storage device is a non-volatile memory unit. The storage device is capable of providing mass storage for the system 106. In one implementation, the storage device is a computer-readable medium. In various different implementations, the storage device can be a floppy disk device, a hard disk device, an optical disk device, a tape device, or a flash memory device. The input/output device provides input/output operations for the system 106. In one implementation, the input/output device includes a keyboard and/or pointing device. In another implementation, the input/output device includes a display unit for displaying graphical user interfaces.

In some implementations, the resource owner devices 104 may communicate wirelessly through a communication interface (not shown), which may include digital signal processing circuitry where necessary. The communication interface may provide for communications under various modes or web protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such Bluetooth, WiFi, or other such transceiver communications.

The network 108 can be a large computer network, such as a local area network (LAN), wide area network (WAN), the Internet, a cellular network, or a combination thereof connecting any number of mobile clients, fixed clients, and/or servers. In some implementations, each client (e.g., client computing device 102) can communicate with one or more of the computer systems 106 via a virtual private network (VPN), Secure Shell (SSH) tunnel, or other secure network connection. The network 108 can include the Internet, a wireless service network and may include the Public Switched Telephone Network (PSTN). In other implementations, the network 108 may include a corporate network (e.g., an intranet) and one or more wireless access points.

The client computing devices 102 and resource owner devices 104 can establish their own sessions with the computer system 106. Each session can involve two-way information exchange between the computer system 106 and the client computing devices 102 and resource owner devices 104. For example, a Hypertext Transfer Protocol (HTTP) session can allow the association of information with individual users. A session can be a stateful session, in which at least one of the communicating parts (e.g., the computer systems 106 or the client computing device 102 or resource owner devices 104) stores information about the session history in order to be able to communicate. Alternatively, stateless communication during a stateless session includes independent requests with associated responses.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

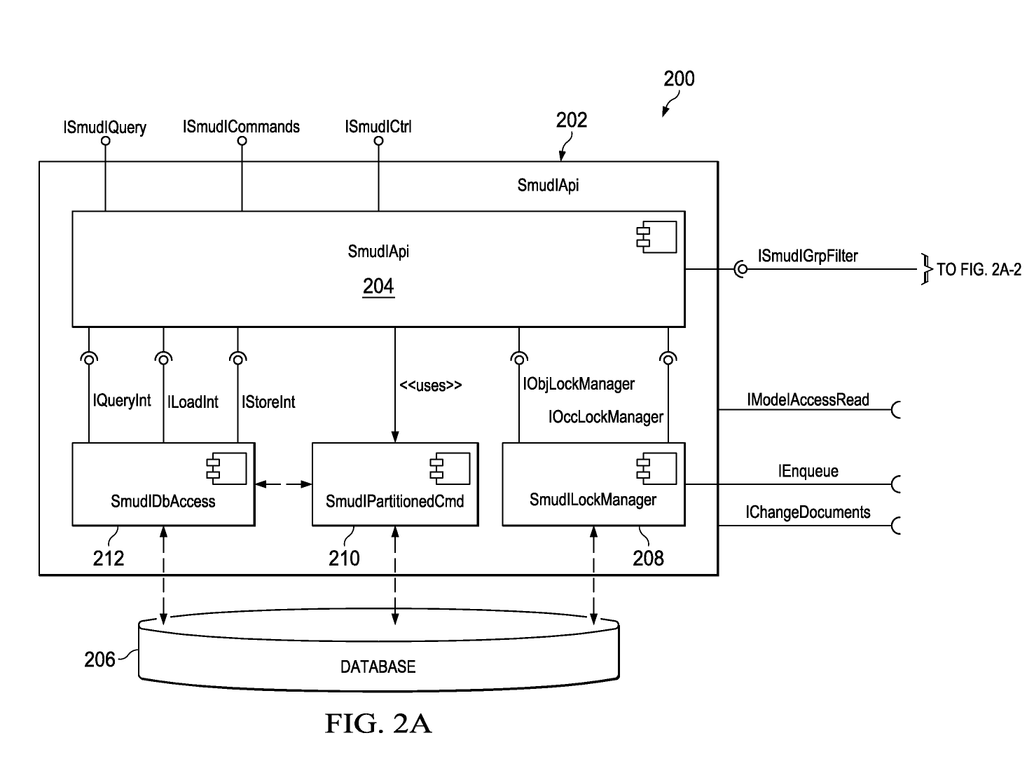

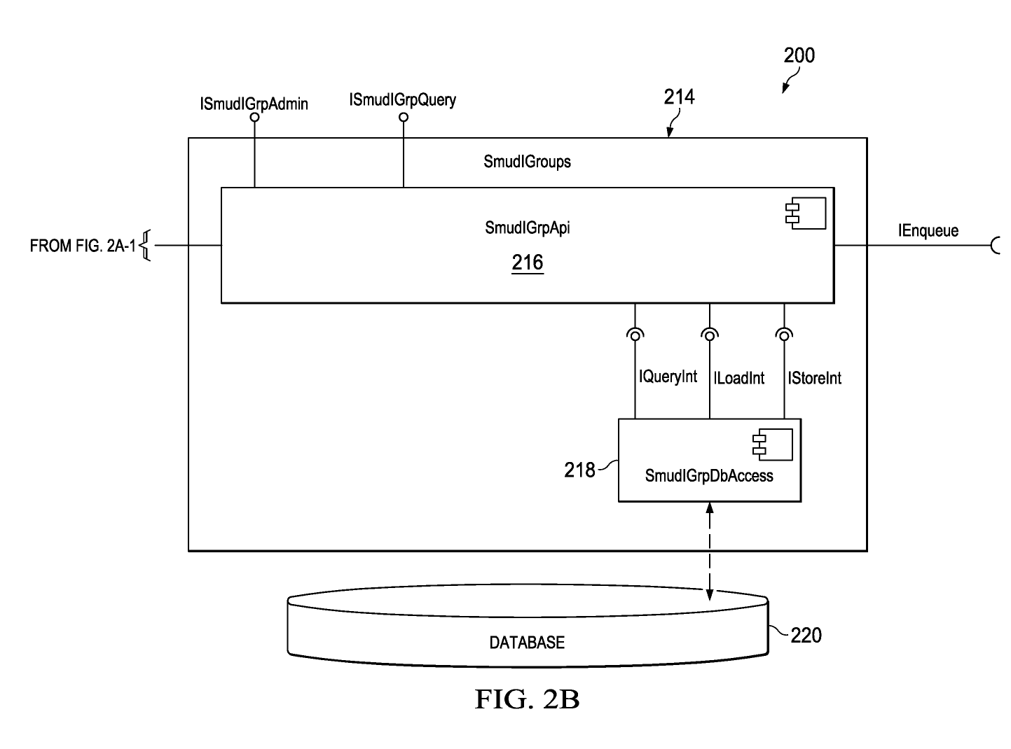

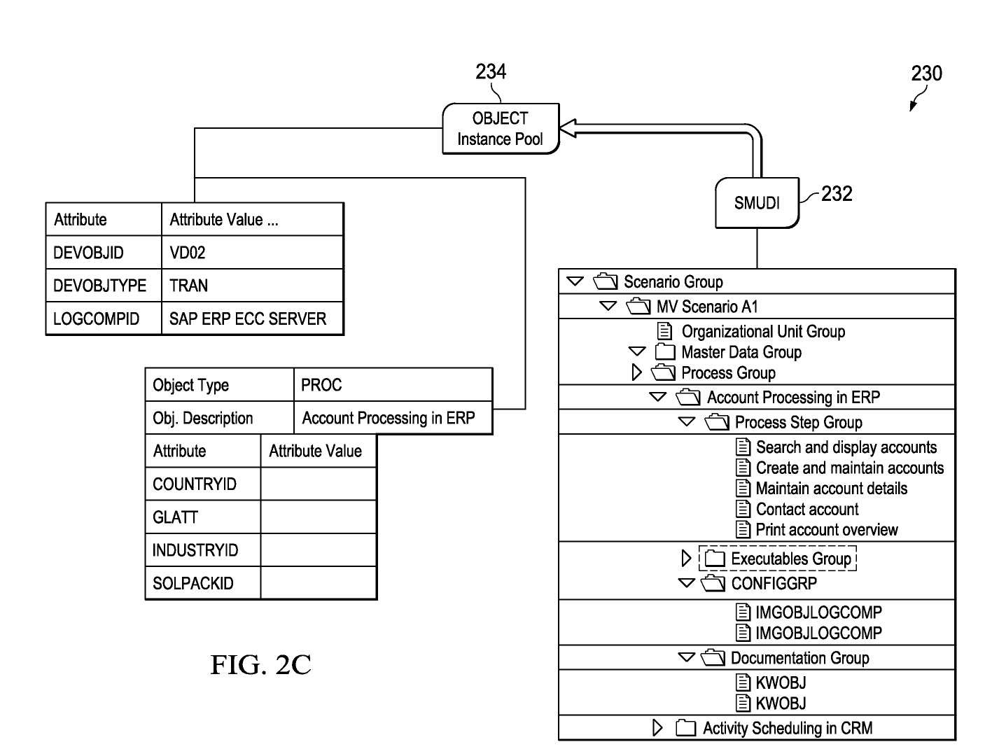

FIG. 2A illustrates an example system architecture 200 for grouping process structures in a SMUD. As illustrated, the architecture 200 includes a SmudIAPI module 202 that includes a SmudIAPI 204 and additional API modules that communicably couple the SmudIAPI 204 to a database 206 (e.g., a relational database, an in-memory database, or other type of database). The illustrated modules include, for example, a SmudILockManager module 208, a SmudIPartitionedCmd module 210, and a SmudIDbAccess module 212. In some aspects, access to SMUD data (e.g., stored in the database 206) may be provided via the provided APIs (e.g., SmudIAPI 204, SmudDBAccess 212 and otherwise) so that it is not possible to access the database layer directly.

The illustrated architecture 200 also includes an SmudIGroups module 214 communicably coupled to the SmudIAPISmudIGrpAPI 216 through a SmudIGrpAPI 216. In some aspects, the SmudIGroups module 214 may provide for generic functionality for groups (e.g., SMUD groups) in the architecture 200. For example, SMUD instances (SMUDI) and SMUD groups may communicate via interfaces as shown in FIG. 2A to filter data from a SMUDI, for example, through the interface ISmudIGrpFilter. Further, SmudIGroups 214 may lock occurrences of a SMUDI, such as through the interface IEnqueue. SmudIApi 204 may also manage change documents, for example, through the interface IChangeDocuments. In some aspects, this may allow occurrences to be stored in groups, occurrences to be locked via the group, and/or change information to be stored on group level.

In the illustrated example, APIs in SmudIGroups 214 may be used to store and retrieve group data (especially occurrences) and perform queries. In addition, the following interfaces may be provided for external users. For example, the interface ISmudIGRPAdmin may create groups, add users to a certain group or remove them, change the permissions of the group, and/or add occurrences and objects to a group or remove them. As another example, the interface ISmudIGRPFilter may be used to perform filter operations on lists of objects or occurrences (e.g., remove all occurrences for a list that have no copy permission). As another example, the interface ISmudIGRPQuery may be used for general queries (e.g., select all member of certain group, select all groups of a certain occurrence, and other queries).

Access to SMUD data, for example in the database 220, may be provided via a SmudIAPI 216 and a SmudDBAccess module 218. In some aspects, access to such SMUD data (e.g., data stored in a header as described below) may only be provided through such APIs, so that it is not possible to access the database layer directly.

FIG. 2B illustrates an example process hierarchy 230 for grouping process structures in a SMUDI 232 (e.g., a SMUD instance). In the illustrated hierarchy 230, the sample process hierarchy and some objects 234 of the object pool are shown, along with attributes of such objects. In some aspects, all attributes, such as description, country, and industry of a business process, are derived from the object 234 of the object pool and can be visualized in the occurrence hierarchy 230. In some aspects, the object pool is transparent to an end user and is only used for performance and data handling reasons. Further, in some examples, access to objects 234 of the pools may be through the occurrence structure, so that for some, most, or all operations (e.g., change, delete, relocate, and others), an occurrence context is available. In this example, the root node of the SMUDI 232 can be seen as a representative of the complete occurrence tree since this is the unique anchor point for the SMUDI 232.

In SMUD, the concept of a process occurrence structure with object links may be used to manage process structures. In this concept, all structure information (e.g., that a process consists of process steps) may be stored in the SMUDI 232. Each node in the SMUDI 232 has an ID. The hierarchical relation, in the illustrated hierarchy 230, is stored as a parent-child relation between the occurrence nodes. In addition, each occurrence node may carry a link to the object 234 of an object pool (e.g., of multiple objects).

In some aspects, data (e.g., attributes) are stored together with the objects 234 in the object pool so that an occurrence node does not have any additional data. Thus, in the illustrated example hierarchy 230, data of an occurrence can be fetched from the object 234.

FIG. 2C illustrates an example group header definition 250 in an architecture for grouping process structures in a SMUD. As illustrated, the definition 250 includes a group header 252 that includes a RootID 254, ID 256, and multiple (in this example) attributes 258. In some aspects, the header 252 defines the SMUD group that includes GroupMembers 260 (e.g., defined by GroupID); GroupOccurences 262 (e.g., defined by various attributes such as the GroupID 256, RootID 254, occurrence ID, or OccID, whether it is active, and when and whom added the occurrence); GroupObjects 264 (e.g., defined by various attributes such as the GroupID 256, object ID, and when and whom added the object); and GroupTypes 266 (e.g., defined by various attributes such as the GroupID 256, object type ID, and when and whom added the object type).

The group header 256 defines the whole group. Since a group might be applied to occurrences or global objects, the GroupOccurences 262 and the GroupObjects 264 is available to store the corresponding group occurrence IDs or object IDs. User information may also be stored in the GroupMembers 260. In some aspects, the GroupMembers 260 can be used to steer authorization features. In addition, it is possible to apply a group to object types of a SMUD model.

In some aspects, certain operations in SMUD can be performed if the correct authorization for the corresponding user is available. In addition, such authorized operations may be reduced to certain parts of the data (e.g., reduced to certain occurrences). As one example, a “scoping” flag can be used to define whether certain occurrences are “in scope” or “out of scope.” This information may then be used by other operations that can then decide whether they operate on all occurrences or only on occurrences that are “in scope” (e.g., a copy function). In some aspects, the default is that all occurrences are “in scope.” Since there may be authorizations, logging, and other features associated with scoping, an ordinary “scope flag” may not be enough to fulfill all requirements. Instead, a scope group is introduced that is based on a SMUD group concept. The scope group can contain all occurrences of a SMUDI that are “out-of-scope.” Since there may be many other groups needed, a SMUD_GROUP table (shown below) may manage different SMUD groups

| SMUD_GROUP | | Remark |
|---|---|---|
| ID | SCOPE | Identifies the group |
| Name | Out of Scope | Describes the group |
| | Group | |
| Root_occ | 1234 | Each group is associated with exactly |
| | | one SMUDI. The SMUDI root |
| | | occurrence ID is used for this. |
| CreatedBy | user | Creator of a Group |
| CreatedAt | Jun. 25, 2013 | |
| CreaterPermissions | none | The authorizations that the creator of |
| | | the group has for the occurrences and |
| | | objects within the group (e.g., none = |
| | | “the creator of the group can execute |
| | | no operation for the occurrences and |
| | | objects in the group”) |
| GroupPermissions | none | The authorizations that all members of |
| | | the group have for the occurrences and |
| | | objects in the group ( e.g. none = “see |
| | | above”) |
| Other | Relocate, | The authorizations that all other users |
| | modify | have (e.g., users that are not the creator |
| | | and not a member of the group) for the |
| | | occurrences and objects in the group ( |
| | | e.g. relocate, modify = “All other users |
| | | have the permissions to relocate and to |
| | | modify the occurrences and objects of |
| | | the group”) |

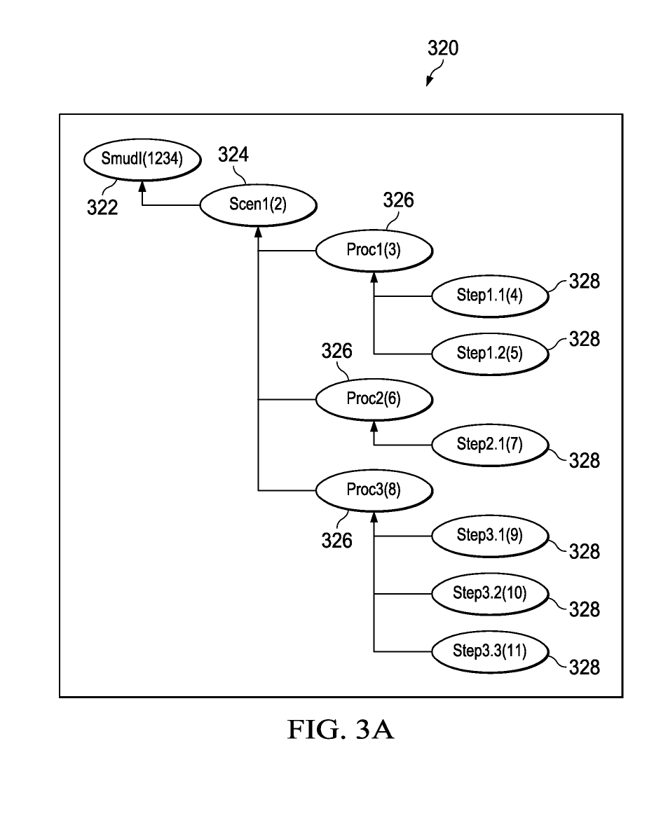

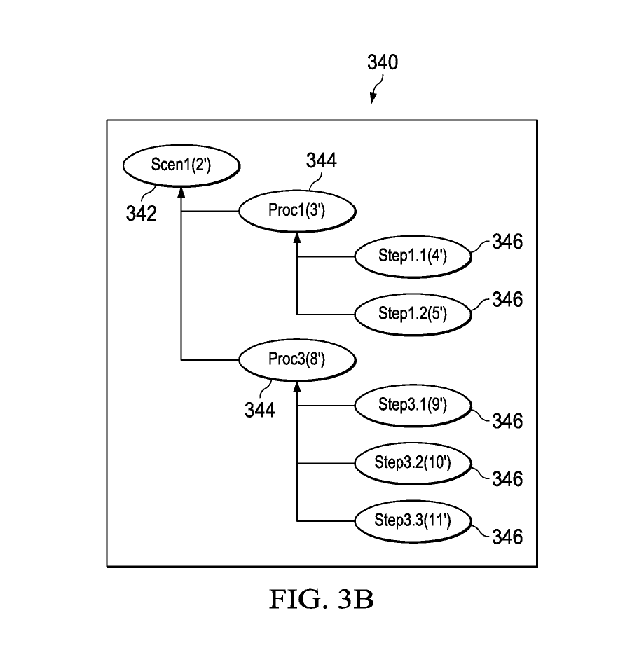

FIGS. 3A-3B illustrate example sub-structures of a SMUD instance in an architecture for grouping process structures in a SMUD. Turning to FIG. 3A, for example, a SMUDI occurrence structure 320 is shown, which includes a SMUDI 322 with a scenario 324 that includes multiple processes 326. Each process 326 includes multiple steps 328, as illustrated. Continuing with the above, “out of scope” example, manipulation operations can be provided generically so that they are available for all SMUD groups. In the above “out of scope” example, various operations may be performed. For example, an occurrence such as occurrence “6” (e.g., in Proc2) may be put “out of scope” by Operation: AddOccurrences (‘SCOPE’, ‘6’). With this operation, occurrence ‘6’ is added to SMUD group “SCOPE.”

Turning to FIG. 3B, for example, an example of a copy scenario operation is illustrated. Here, a user may copy a scenario (e.g., Scen1) from the occurrence structure 320 from one SMUDI to another SMUDI, shown as occurrence structure 340 in FIG. 3B. The SMUDI occurrence structure 340, as shown, includes a scenario 342 that includes multiple processes 344. Each process 344 includes multiple steps 346, as illustrated. In this example, operation, “in scope” occurrences may be taken into account, and since the occurrence ID of Scen1 is ‘2,’ the following operation can be performed: Copy(2,{SCOPE}. The following filter is now used: filterOccPermissionCopy (User=MN,{3,4,5,6,7,8,9,10,11}). This results, as illustrated, in {3,4,5,8,9,10,11} and, therefore, Scen1 will be copied taking the ‘Scope’ group into account. This leads to the result that process Proc2 (and its children) is omitted, since Proc2 was previously set “out of scope” as explained with reference to FIG. 3A.

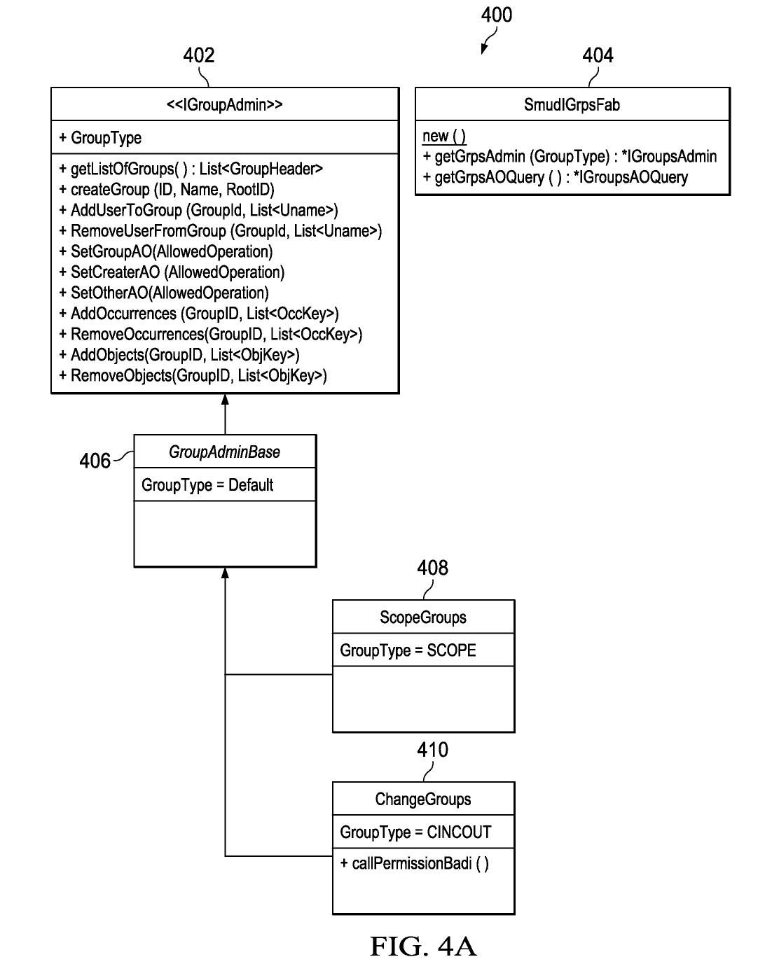

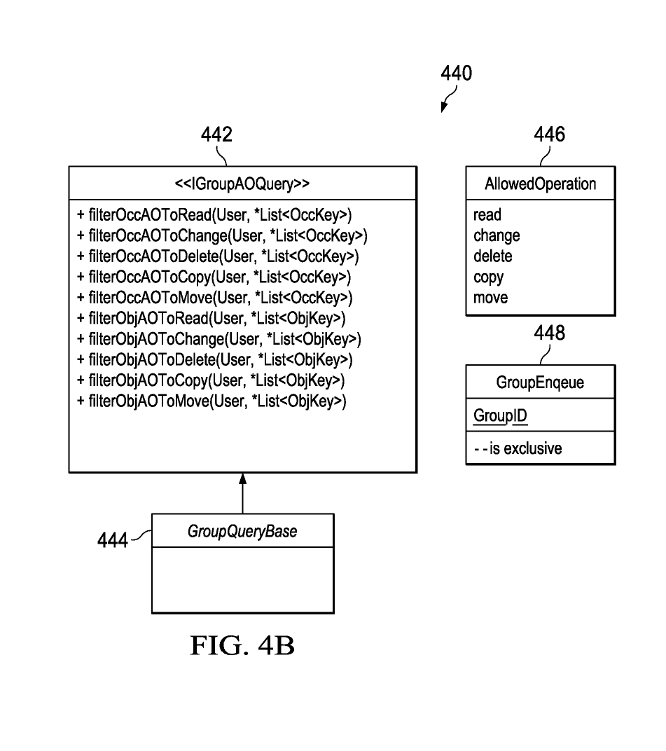

FIGS. 4A-4B illustrate example group interface hierarchies for grouping process structures in a SMUD. Turning to FIG. 4A, for example, the interface hierarchy 400 illustrates group APIs in more detail. In this example, the super classes, such as IGroupAdmin 402 and SmudIGrpsFab 404 may provide for all of the functionality of a SMUDI group in a generic way. Case specific features, if needed by the SMUDI group, may be provided by a sub-class, such as, for example, the sub-classes needed by a special group. A sub-class may provide these feature as indicated by sub-classes ScopeGroups 408 and ChangeGroup 410.

Turning to FIG. 4B, the interface hierarchy 440 illustrates additional group APIs in more detail. In this example, the super classes IGroupAOQuery 442 and Allowed Operation 446 may provide for all of the functionality of a SMUDI group in a generic way. Illustrated sub-classes include GroupQueryBase 444 and GroupEnqueue 448

In some aspects, authorization and permission features may be provided via the “group member:” In one example method for providing authorization and permission features, a check is first conducted as to whether a current user exists (e.g., test if the user name is initial). If, in one example, the user is the creator of the group, this check is confirmed from the group header (as shown in the table above). Thus, corresponding authorization as defined in the header is provided. If the user has not created the group, then the check is confirmed against the defined group membership attributes. Depending on the result of this check, the corresponding authorization may be provided (or not, if the user is not among the group membership attributes).

Several examples are disclosed herein, in addition to the scoping example provided above. One example is a “Change Groups” example. In this example, changes to an occurrence may only be possible via a “change request.” In some aspects, changes shall be applied to “inactive” versions of the occurrences and, for example, may only be possible by authorized users. A change request can be supported via a “change group” that is defined in a similar way as the “scope group,” as shown in the following table.

| CHANGE_GROUP | | Remark |
|---|---|---|
| ID | Change | Change group identifier |
| Name | Change Group | Change Group |
| Root_occ | 1234 | SMUD Occurrence Root Node |
| CreatedBy | user | User who has created the group |
| CreatedAt | Sep. 10, 2012 | |
| CreaterPermissions | all | The creator and all members of the |
| | | change group can perform any |
| | | operation on the occurrences and |
| | | objects in the group |
| GroupPermissions | all | |
| Other | none | |

For example, with reference to FIG. 3A, a sample occurrence hierarchy with root 1234 is illustrated. A change request for process Proc1 (occurrence ID 3) is created. Since a change request for a process may also encompass the corresponding process steps of the process, also Step1.1 and Step 1.2 are involved. This may be realized in the following way based on the group concept. First, a user creates a change request for Proc1. Next, a change with ID 23 for SMUDI 1234 is created for the change group: ChangeAdmin.createChange(1234, . . . ):CHANGE_ID=23. Next, the affected occurrences are calculated (Proc1, Step1.1, Step 1.2): SmudIQuery.readOccurrenceStructure(3):{4,5}. Next a change group is created and member “MN” is added to the member group with read and change authorization: SmudiGrpsAdmin.createGroup(ID=23,RootId=1234, . . . ), SmudiGrpsAdmin.addMember({MN}),SmudiGrpsAdmin.setGroupAO(read=X,change=X . . . ), and SmudiGrpsAdmin.setOtherAO(none). Next, occurrences are added to group 23: SmudiGrpsAdmin.addOccurrences({3,4,5}). Next, inactive occurrences are created for the occurrences in the new group: SmudICmd.SetToInactive({3,4,5}). Finally, an authorization check for occurrence 4 (Step 1.1) is performed if an attribute is to be changed by user “MN” (group member) or by user “MV” (not a group member): SmudiCmd.setAttribute({4} . . . ),SmudiGrpsAOFilter.filterOccAOChange(MN,{4})→{4}→change possible, and SmudiGrpsAOFilter.filterOccAOChange(MV,{4})→{ }→change not possible.

This example shows that the group concept fits well to the requirements. In many cases, the provided generic functionality for groups can be used so that only a minimum of specific functionality needs to be implemented in a sub-class for “change groups.”

Another example is a “Blueprint Lock.” There may be two options for the “Blueprint Lock”: an Edit Structures in which the structure (e.g., all occurrences of a SMUDI) may not be edited anymore; or an Edit Structures, Change Documents and Administration Data in which additional change of blueprint relevant documentation and the administration data is not allowed.

In this use case, a “blueprint lock group” may be defined to fulfill the above requirements.

| BLUEPRINT_LOCK_GROUP | | Remark |
|---|---|---|
| | | Blueprint lock group |
| ID | BLUEPRINTLOCKSTRUC | identifier |
| Name | Blueprint Lock | Blueprint Lock Group |
| | Group | |
| Root_occ | 1234 | SMUD Occurrence Root Node |
| CreatedBy | user | User who has created the group |
| CreatedAt | Sep. 10, 2012 | |
| CreaterPermissions | read, copy | As long as the blueprint lock is active |
| | | all users have only the permissions to |
| | | read or copy the occurrences and |
| | | objects in the group |
| GroupPermissions | read, copy | |
| Other | read, copy | |

In the SMUDI of FIG. 3A, a blueprint lock is to be defined by the following example process. First, a user may activate a Blueprint Structure Lock for SMUDI 1234: Root.ProjSolAdmGrp.LockOptGroup.BlueprintLockStruc.setAttribute(ISACTIVE=abap_true). Second, the affected occurrences/objects are determined: SmudIQuery.readOccurrenceStructure(1):{2,3,4,5 . . . }. Next, the group is locked for the SMUDI: SmudiGrpsAdmin.lockGroup(groupID). Next, the blueprint lock group is created: SmudiGrpsAdmin.createGroup(GroupType=BLUEPRINTLOCKSTRUC RootId=1234, . . . ),SmudiGrpsAdmin.setOtherAO(read, copy). Next, affected occurrences are added to group: SmudiGrpsAdmin.addOccurrences({1,2,3,4,5}). Next, affected objects are added to group (e.g., global objects that are referenced by the occurrences): SmudiGrpsAdmin.addObjects({O1, O2, O3}). Next, the group is unlocked: SmudiGrpsAdmin.unlockGroup(groupID). Next, the change is checked: SmudiCmd.setAttribute({4}),SmudiGrpsAOFilter.filterOccAOChange(MN,{4})→{ }→change not possible.

In another example, the SMUDI group concept can be applied to object types defined via the SMUD models. For example, the SMUD Instances may be based on a SMUD Model. The model defines the object types, their attributes, and relations. In some cases, it may be more effective to define groups using the object types and not the instances of the objects (e.g., occurrence IDs). For example, continuing the above Blueprint Lock example, this can be defined so that the lock should affect only the process structure (e.g., no user should change the processes or scenarios but it should be possible to add more content (documents)). To that end, “Structure objects types” can be added to the group: SmudIModel.getAllStructureTypes( ):{SCN,PROC,PROCSTEP, . . . }, and SmudiGrpsAdmin.addTypes({SCN,PROC,PROCSTEP, . . . }). Now the permissions of this group apply to all occurrences and objects within the SMUDI with the given types and each instance of the type need not be added individually.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order (e.g., FIG. 5), this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure.

What is claimed is:

1. A computer-implemented method for managing business process functionality, comprising:
defining a group for a solution manager unified directory (SMUD), the defined group comprising a group identification (ID) and a plurality of members of the group, each member comprising a business process structure;
defining a plurality of generic functions of the group;
receive a request for an adjustment to the plurality of generic functions of a particular member of the plurality of members of the group; and
based on the received request, adjusting the plurality of generic functions of members of the group other than the particular member.

2. The computer-implemented method of claim 1, wherein the defined group further comprises a group header that includes the group ID and the plurality of members of the group, the group header further including one or more user authorizations, the user authorizations defining approved adjustments to the plurality of generic functions.

3. The computer-implemented method of claim 2, wherein the one or more user authorizations comprise a creator authorization and one or more group authorizations.

4. The computer-implemented method of claim 3, further comprising:
based on the received request, determining a user that made the request;
checking the user and the request against the user authorizations; and
based on the user and request being an approved adjustment, adjusting the plurality of generic functions.

5. The computer-implemented method of claim 1, wherein the adjustment to the plurality of generic functions comprises at least one of:
an addition of a new function;
a change to an authorization level of a user;
an addition of a new member to the members of the group; or
a change to data in at least one of the members of the group.

6. The computer-implemented method of claim 1, wherein adjusting the plurality of generic functions of members of the group other than the particular member comprises adjusting the plurality of generic functions of members of the group other than the particular member without adding code to any of the members of the group.

7. The computer-implemented method of claim 1, wherein at least a portion of the plurality of generic functions comprises a read function, a copy function, and a delete function.

8. A computer storage medium encoded with a computer program, the program comprising instructions that when executed by one or more computers cause the one or more computers to perform operations comprising:
defining a group for a solution manager unified directory (SMUD), the defined group comprising a group identification (ID) and a plurality of members of the group, each member comprising a business process structure;
defining a plurality of generic functions of the group;
receive a request for an adjustment to the plurality of generic functions of a particular member of the plurality of members of the group; and
based on the received request, adjusting the plurality of generic functions of members of the group other than the particular member.

9. The computer storage medium of claim 8, wherein the defined group further comprises a group header that includes the group ID and the plurality of members of the group, the group header further including one or more user authorizations, the user authorizations defining approved adjustments to the plurality of generic functions.

10. The computer storage medium of claim 9, wherein the one or more user authorizations comprise a creator authorization and one or more group authorizations.

11. The computer storage medium of claim 10, wherein the operations further comprise:
based on the received request, determining a user that made the request;
checking the user and the request against the user authorizations; and
based on the user and request being an approved adjustment, adjusting the plurality of generic functions.

12. The computer storage medium of claim 8, wherein the adjustment to the plurality of generic functions comprises at least one of:
an addition of a new function;
a change to an authorization level of a user;
an addition of a new member to the members of the group; or
a change to data in at least one of the members of the group.

13. The computer storage medium of claim 8, wherein adjusting the plurality of generic functions of members of the group other than the particular member comprises adjusting the plurality of generic functions of members of the group other than the particular member without adding code to any of the members of the group.

14. The computer storage medium of claim 8, wherein at least a portion of the plurality of generic functions comprises a read function, a copy function, and a delete function.

15. A system of one or more computers configured to perform operations comprising:
defining a group for a solution manager unified directory (SMUD), the defined group comprising a group identification (ID) and a plurality of members of the group, each member comprising a business process structure;
defining a plurality of generic functions of the group;
receive a request for an adjustment to the plurality of generic functions of a particular member of the plurality of members of the group; and
based on the received request, adjusting the plurality of generic functions of members of the group other than the particular member.

16. The system of claim 15, wherein the defined group further comprises a group header that includes the group ID and the plurality of members of the group, the group header further including one or more user authorizations, the user authorizations defining approved adjustments to the plurality of generic functions.

17. The system of claim 16, wherein the one or more user authorizations comprise a creator authorization and one or more group authorizations.

18. The system of claim 17, wherein the operations further comprise:
based on the received request, determining a user that made the request;
checking the user and the request against the user authorizations; and
based on the user and request being an approved adjustment, adjusting the plurality of generic functions.

19. The system of claim 15, wherein the adjustment to the plurality of generic functions comprises at least one of:
an addition of a new function;
a change to an authorization level of a user;
an addition of a new member to the members of the group; or
a change to data in at least one of the members of the group.

20. The system of claim 15, wherein adjusting the plurality of generic functions of members of the group other than the particular member comprises adjusting the plurality of generic functions of members of the group other than the particular member without adding code to any of the members of the group.

21. The system of claim 15, wherein at least a portion of the plurality of generic functions comprises a read function, a copy function, and a delete function.
